(19) United States
(12) Patent Application Publication
(10) Pub. No.: US 2017/0031626 A1
(43) Pub. Date: Feb. 2, 2017

(54) STORAGE DEVICE INCLUDING NON-VOLATILE MEMORY DEVICE AND PROGRAM METHOD THEREOF

(71) Applicant: SAMSUNG ELECTRONICS CO., LTD., SUWON-SI (KR)

(72) Inventors: CHOLMIN KIM, CHANGWON-SI (KR); JIYONG LEE, ANYANG-SI (KR); JUNGYOUNG KIM, SEOUL (KR)

(21) Appl. No.: 15/090,761

(22) Filed: Apr. 5, 2016

(30) Foreign Application Priority Data
Jul. 30, 2015 (KR) 10-2015-0108181

(51) Int. Cl. G06F 3/06

(52) U.S. Cl. CPC G06F 3/0647; G06F 3/0616; G06F 3/0656; G06F 3/0679

(57) ABSTRACT

A storage device includes a nonvolatile memory device and a memory controller. The nonvolatile memory device includes memory blocks divided into a buffer region and a main region. The memory controller controls the nonvolatile memory device to perform a buffer program operation to program externally provided data into the buffer region, a migration program operation to migrate data stored in the storage device to the main region, and a direct program operation to program externally provided data into the main region. The direct program operation is performed when the size of the externally provided data is larger than that of an available programmable region in the buffer region, and the migration program operation is performed to migrate some of the data programmed into the buffer region to the main region after the direct program operation is performed.

### CROSS-REFERENCE TO RELATED APPLICATIONS

This application claims priority under 35 USC §119 to Korean Patent Application No. 10-2015-0108181, filed on Jul. 30, 2015, the disclosure of which is incorporated by reference herein in its entirety.

### BACKGROUND

The present disclosure relates to a semiconductor memory device and, more particularly, to a storage device including a nonvolatile memory device and a program method thereof.

In general, semiconductor memory devices may be classified as volatile memory devices and nonvolatile memory devices. Volatile memory devices perform a high-speed read operation but lose their stored data when their power supplies are interrupted. Meanwhile, nonvolatile memory devices retain their stored data even when their power supplies are interrupted. Accordingly, nonvolatile memory devices are used to store data that needs to be retained, irrespective of whether their power supplies are interrupted.

Nonvolatile memory devices include a mask read only memory (MROM), a programmable read only memory (PROM), an erasable programmable read only memory (EPROM), and an electrically erasable programmable read only memory (EERPOM).

A representative example of nonvolatile memory devices is a flash memory device. Flash memory devices have been used as voice and image data storage media in electronic devices, such as a computer, a mobile phone, a personal digital assistant (PDA), a digital camera, a camcorder, a voice recorder, an MP3 player, a portable multimedia player (PMP), a handheld PC, a game player, a facsimile, a scanner, and a printer (hereinafter each being referred to as “host”).

With the recent increasing demand for high capacity of memory devices, multi-level cell (MLC) or multi-bit cell memory devices to store two or more bits in a single memory cell have been widely used.

### SUMMARY

The present disclosure relates to a storage device and a program method thereof.

A storage device according to example embodiments of the disclosure includes a nonvolatile memory device having memory blocks divided into a buffer region and a main region. A memory controller controls the nonvolatile memory device to perform a buffer program operation to program externally provided data into the buffer region, a migration program operation to migrate data stored in the storage device to the main region, and a direct program operation to program externally provided data into the main region. The direct program operation may be performed when the size of the externally provided data is larger than that of an available programmable region in the buffer region. The migration program operation may be performed to migrate some of the data, programmed into the buffer region, to the main region after the direct program operation is performed.

In example embodiments, the direct program operation and the migration program operation may be alternately performed until the size of the available programmable region in the buffer region is made large than that of the externally provided data.

In example embodiments, the buffer program operation is performed on the externally provided data when the size of the available programmable region in the buffer region is made larger than that of the externally provided data.

In example embodiments, the size of the migrated data may be a page size of the nonvolatile memory device or an integer multiple of the page size.

A program method of a nonvolatile memory device according to example embodiments of the disclosure includes a first program operation to program data input externally, in an input unit of a set size, into a first memory region. A second program operation programs externally input data into a second memory region when the first memory region is fully programmed with externally input data. A third program operation migrates some of the data programmed into the first memory region to the second memory region. A size of the migrated data may correspond to a page size of the nonvolatile memory device or an integer multiple of the page size.

A method, executed by a memory controller, of programming data into a nonvolatile memory having a buffer region and a main region, includes: a) receiving an input unit of data from a host device; b) programming the input unit of data into the buffer region when the buffer region has enough available memory to store the input unit of data; c) programming the input unit of data into the main region when the buffer region does not have enough available memory to store the input unit of data; and d) migrating a migration unit of data stored in the buffer region to the main region after programming the input unit of data into the main region and before programming additional data, received from the host, into either the buffer region or the main region, the migration unit being less than all of the data stored in the buffer region.

### BRIEF DESCRIPTION OF THE DRAWINGS

The forgoing and other features of the disclosure will be described below in more detail with reference to the accompanying drawings of non-limiting embodiments of the disclosure in which like reference characters refer to like parts throughout the different views. The drawings are not necessarily to scale, emphasis instead being placed upon illustrating principles of the disclosure. In the drawings:

FIG. 1 is a block diagram of a storage device according to example embodiments of the disclosure;

FIG. 2 is a block diagram illustrating an exemplary detailed configuration of a memory controller in FIG. 1;

FIG. 3 is a detailed block diagram of the nonvolatile memory device in FIG. 1;

FIG. 4 is a block diagram illustrating a programming sequence of the nonvolatile memory device in FIG. 3;

FIGS. 5A to 5D are block diagrams illustrating a program method according to example embodiments of the disclosure when an input/output unit and a migration unit are equal to each other;

FIGS. 6A to 6D are block diagrams illustrating a program method according to example embodiments of the disclosure when an input/output unit is larger than a migration unit;

FIG. 7 is a graph illustrating WAF variation depending on an input/output unit when a program method according to example embodiments of the disclosure is used;

FIG. 8 is a circuit diagram of one of the memory blocks included in a memory cell array in FIG. 3;

FIG. 9 is a flowchart summarizing a program operation according to example embodiments of the disclosure;

FIG. 10 is a block diagram of a memory system including a storage device according to example embodiments of the disclosure;

FIG. 11 is a block diagram of a memory card system to which a storage device according to example embodiments of the disclosure is applied; and

FIG. 12 is a block diagram of a solid state drive (SSD) system to which a storage device according to example embodiments of the disclosure is applied.

### DETAILED DESCRIPTION

Example embodiments will now be described more fully with reference to the accompanying drawings, in which some example embodiments are shown. Example embodiments may, however, be embodied in many different forms and should not be construed as being limited to the embodiments set forth herein; rather, these example embodiments are provided so that this disclosure will be thorough and complete, and will fully convey the scope of example embodiments of the disclosure to those of ordinary skill in the art. In the drawings, the thicknesses of layers and regions are exaggerated for clarity. Like reference characters and/or numerals in the drawings denote like elements, and thus their repeated description may be omitted.

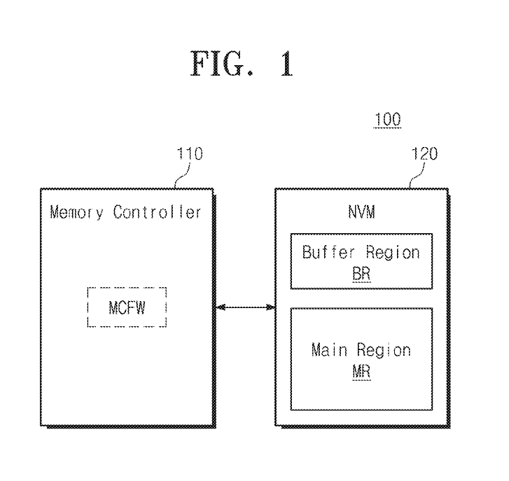

FIG. 1 is a block diagram of a storage device 100 according to example embodiments of the disclosure. As illustrated, the storage device 100 may include a memory controller 110 and a nonvolatile memory device 120.

The memory controller 110 may control the nonvolatile memory device 120 in response to a request (e.g., a write request, a read request, etc.) from an external device (e.g., a host). The memory controller 110 may control the nonvolatile memory device 120 according to an internal request (e.g., an operation associated with sudden power-off, a wear-leveling operation, a read reclaim operation, etc.) without an external request. An operation corresponding to the internal request of the memory controller 110 may be performed within a timeout period of a host after a request of the host is processed. Alternatively, an operation corresponding to the internal request of the memory controller 110 may be performed at an idle time of the memory controller 110. The nonvolatile memory device 120 may operate in response to the control of the memory controller 110 and may be used as a type of storage medium to store data. The storage medium may include one or more memory chips. The nonvolatile memory device 120 and the memory controller 110 may communicate with each other through one or more channels. The nonvolatile memory device 120 may include, for example, a NAND flash memory device.

The memory controller 110 may execute migration control firmware (MCFW) stored in an internal memory such as, for example, static random access memory (SRAM) or read only memory (ROM). When the migration control firmware (MCFW) is executed, the memory controller 110 may control the nonvolatile memory device 120 to perform a program operation according to the migration control firmware (MCFW).

When the migration control firmware (MCFW) is executed, the memory controller 110 controls the nonvolatile memory device 120 to program externally transmitted data into a buffer region BR of the nonvolatile memory device 120. The externally provided data may be transmitted to the storage device 100 in an input/output (I/O) unit that is a set-size unit. An external device such as a host transmits data to be programmed to the storage device 100 after dividing the data into I/O unit data. The memory controller 110 may program the next I/O unit data into the nonvolatile memory device 120 when programming data into a single I/O unit is completed. A size of the I/O unit may be set by the host. For example, when data that must be stored such as a music file and a media file is relatively large, the host may set an I/O unit to be large according to the type of an application. Meanwhile, when data that must be stored, such as a document file, is relatively small, the host may set an I/O unit to be small.

When the buffer region BR is all programmed with data (i.e., there is no remaining programmable region), the memory controller 110 controls the nonvolatile memory device 120 to program externally transmitted data of a single I/O unit into a main region MR. That is, the externally input data is programmed directly into the main region MR without passing through the buffer region BR.

The memory controller 110 migrates data to be programmed into the buffer region BR to the main region MR by a migration unit of set size after performing a program operation on the main region MR. That is, data having the same size as a set migration unit is programmed after migrating from the buffer region BR to the main region MR. The migration unit may be a data unit having a smaller size than the buffer region BR.

After the migration program operation, the memory controller 110 compares an input data size of I/O unit with a programmable region in the buffer region BR after the migration program operation. If the size of the programmable region in the buffer region BR is larger than or equal to that of I/O unit, the memory controller 110 controls the nonvolatile memory device 120 to program input data into the buffer region BR. If the size of the programmable region in the buffer region BR is less than that of I/O unit, the memory controller 110 controls the nonvolatile memory device 120 to program input data into the main region MR.

The memory controller 110 controls the nonvolatile memory device 120 to perform a program operation and a migration program operation on the main region MR until the size of the programmable region in the buffer region is made larger than or equal to the size of I/O unit. At this point, the migration program operation is performed on data of a migration unit having a set size. That is, the data of migration unit having a set size is programmed during the migration program operation performed once after migrating from the buffer region BR to the main region MR.

As described above, the memory controller 110 controls the nonvolatile memory device 120 to repeatedly perform a buffer program operation, a migration program operation, and a direct program operation until all externally input data is completely programmed. That is, the nonvolatile memory device 120 migrates only some data having a migration unit, i.e., a set size to the main region MR without migration of all data programmed into the buffer region BR when the buffer region BR is full.

With the program operation according to the migration control firmware (MCFW), a write amplification factor (WAF) of a nonvolatile memory device may be improved to increase the life of the nonvolatile memory device.

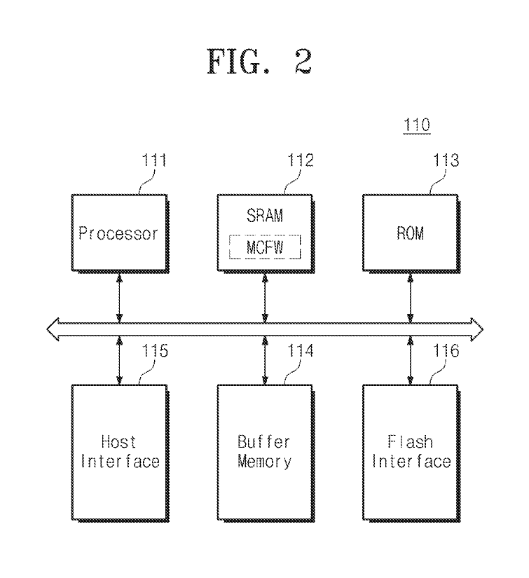

FIG. 2 is a block diagram illustrating an exemplary detailed configuration of the memory controller 110 in FIG. 1. As illustrated, the memory controller 110 includes a processor 111, an SRAM 112, a ROM 113, a buffer memory 114, a host interface 115, and a flash interface 116.

The processor 111 may control the overall operation of the memory controller 110. The SRAM 112 may be used as a cache memory, a main memory or the like of the memory controller 110. In example embodiments, the above-described migration control firmware (MCFW) may be stored in the SRAM 112. The ROM 113 may store various information required to operate the memory controller 110, in the form of firmware. In example embodiments, data, information or firmware stored in the SRAM 112 or the ROM 113 may be managed or executed by the processor 111.

The buffer memory 114 may temporarily store information, a program, write data or read data required to operate the memory controller 110.

The memory controller 110 may communicate with an external device through the host interface 115. In example embodiments, the host interface 115 may provide at least one of various interfaces such as USB (universal serial bus), MMC (multimedia card), embedded-MMC, PCI (peripheral component interconnection), PCI express, ATA (advanced technology attachment), serial-ATA, parallel-ATA, SCSI (small computer small interface), ESDI (enhanced small disk interface), IDE (integrated drive electronics), Firewire, and UFS (universal flash storage). Although not shown in the drawing, the memory controller 110 may communicate with an external device through a separate communication channel.

The memory controller 110 may communicate with the nonvolatile memory device 120 (see FIG. 1) through the flash interface 116.

When the migration control firmware MCFW stored in the SRAM 112 is executed by the processor 111, the nonvolatile memory device 120 may be controlled to perform the program operations described with reference to FIG. 1.

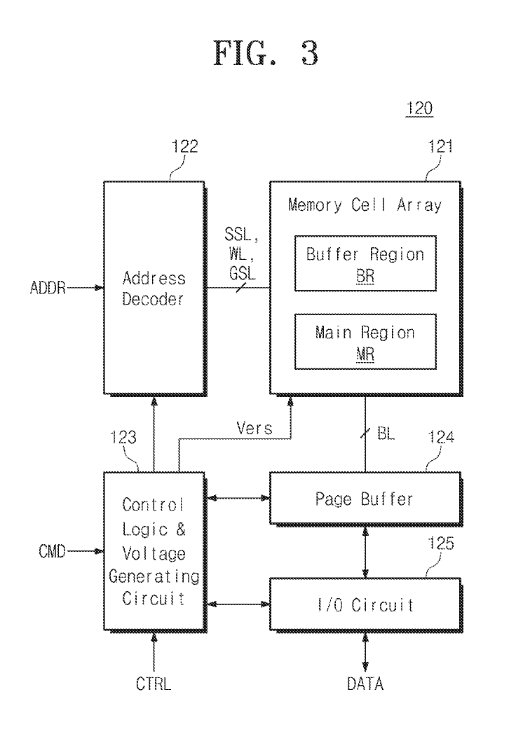

FIG. 3 is a detailed block diagram of the nonvolatile memory device 120 in FIG. 1. As illustrated, the nonvolatile memory device 120 includes a memory cell array 121, an address decoder 122, a control logic and voltage generating circuit 123, a page buffer 124, and an input/output (I/O) circuit 125. The memory cell array 121 may include a buffer region BR and a main region MR.

The memory cell array 121 includes a plurality of memory blocks each including a plurality of memory cells. The memory cells may be connected to a plurality of wordlines WL, respectively. Each of the memory cells may include a single-level cell (SLC) storing one bit of data or a multi-level cell (MLC) storing at least two bits of data. A memory region constituting the memory cell array 121 may be roughly divided into a buffer region BR and a main region MR. In example embodiments, the buffer region BR may include memory cells of a single-level cell (SLC) and the main region MR may include memory cells of a multi-level cell (MLC).

The address decoder 122 may be connected to the memory cell array 121 through a plurality of wordlines WL, string selection lines SSL, and ground selection lines GSL. The address decoder 122 may receive an address ADDR from the storage controller 110 and decode the received address ADDR. The address decoder 122 may decode the address ADDR received from the memory controller 110 and select at least one of the wordlines WL based on the decoded address ADDR to control the selected at least one wordline.

The control logic and voltage generating circuit 123 may receive a command CMD and a control signal CTRL from the memory controller 110 and control the address decoder 122, the page buffer 124, and the I/O circuit 125 in response to received signals. For example, the control logic and voltage generating circuit 123 may control the address decoder 122, the page buffer 124, and the I/O circuit 125 to write data DATA received from the memory controller 110 into the memory cell array 121 or to read data stored in the memory cell array 121. Additionally, the control logic and voltage generating circuit 123 may apply an erase voltage Vers to a substrate of the memory cell array 121 during an erase operation.

The control logic and voltage generating circuit 123 may generate various voltages required to operate the nonvolatile memory device 120. For example, the control logic and voltage generating circuit 123 may generate various voltages such as a plurality of program voltages, a plurality of pass voltages, a plurality of selected read voltages, a plurality of unselected read voltages, a plurality of erase voltages, and a plurality of verify voltages.

The page buffer 124 is connected to the memory cell array 121 through a plurality of bitlines BL. The page buffer 124 may control the bitlines BL based on the data DATA received from the I/O circuit 125 under the control of the control logic and voltage generating circuit 123. The page buffer 124 may read data stored in the memory cell array 121 and transmit the read data to the I/O circuit 125 according to the control of the control logic and voltage generating circuit 123. In example embodiments, the page buffer 124 may receive data from the I/O circuit 125 in units of pages or read data from the memory cell array 121 in units of pages. In example embodiments, the page buffer 124 may perform a buffer program operation, a direct program operation, and a migration program operation according to disclosure. In example embodiments, the page buffer 124 may include data latches to temporarily store data read from the memory cell array 121 or data received from the I/O circuit 125.

The I/O circuit 125 may receive data DATA from an external device and transmit the received data DATA to the page buffer 124. Alternatively, the I/O circuit 125 may receive data DATA from the page buffer 124 and transmit the received data DATA to an external device. In example embodiments, the I/O circuit 125 may transmit/receive data DATA to/from an external device in synchronization with a control signal CTRL. In example embodiments, data transmitted from an external device may be transmitted in an input/output (I/O) unit of a set size. For example, the I/O unit may be 16 KB, 32 KB, 256 KB, 1 MB, or 4 MB. The I/O unit may be variously set by the external device.

In example embodiments of the disclosure, a three-dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In example embodiments of the disclosure, the 3D memory array includes vertical NAND strings that are vertically oriented such that at least one memory cell is located over another memory cell. The at least one memory cell may comprise a charge trap layer. Each vertical NAND string may include at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with wordlines and/or bitlines shared between levels: U.S. Pat. Nos. 7,679,133; 8,553,466; 8,654,587; 8,559,235; and US Pat. Pub. No. 2011/0233648.

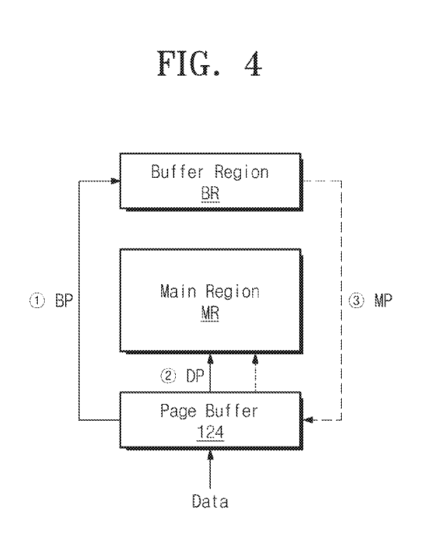

FIG. 4 is a block diagram illustrating a programming sequence of the nonvolatile memory device 120 in FIG. 3. Referring to FIG. 4, the page buffer 124 programs externally provided data into the buffer region BR (\textcircled{1}). The externally provided data may be provided in an input/output (I/O) unit of a set size. The page buffer 124 programs the externally provided data of the I/O unit into the buffer region BR until the programmable region in the buffer region BR is full (i.e., the buffer region BR becomes full). When the buffer region BR becomes full by a program operation into the buffer region BR, the page buffer 124 programs the externally provided data into the main region MR (\textcircled{2}). That is, the page buffer 124 directly programs data into the main region MR. The data programmed into the main region 124 may be data corresponding to a single I/O unit.

After the program operation into the main region 124, the page buffer 124 performs a migration program operation (\textcircled{3}) to migrate the data in the buffer region BR to the main region MR. A size of the data migrating to the main region MR is a size corresponding to a predetermined migration unit. The migration unit is a predetermined value, which may be set to a page unit of the nonvolatile memory device 120 or an integer fraction or multiple of the page unit. For example, if the page unit of the nonvolatile memory device 120 is a unit of 64 KB, the migration unit may be set to 16 KB, 32 KB, 64 KB or the like.

The nonvolatile memory device 120 migrates only data of a set size to the main region MR during a program operation performed once. The direct program operation (\textcircled{2}) and the migration program operation (\textcircled{3}) may be alternately performed until a size of the programmable region in the buffer region BR is made larger than or equal to a data size corresponding to an I/O unit.

According to the above-described program method, only data of a set size migrates to a main region MR during each migration program operation. Accordingly, when a buffer region BR becomes full, a WAF may increase as compared to a conventional way to migrate all data in the buffer region BR. That is, compared with a size of externally provided data, a size of data actually programmed into the nonvolatile memory device 120 may be reduced to be smaller than in the conventional way. Thus, the life of the buffer region BR may be increased. As a result, the life of the nonvolatile memory device 120 may increase.

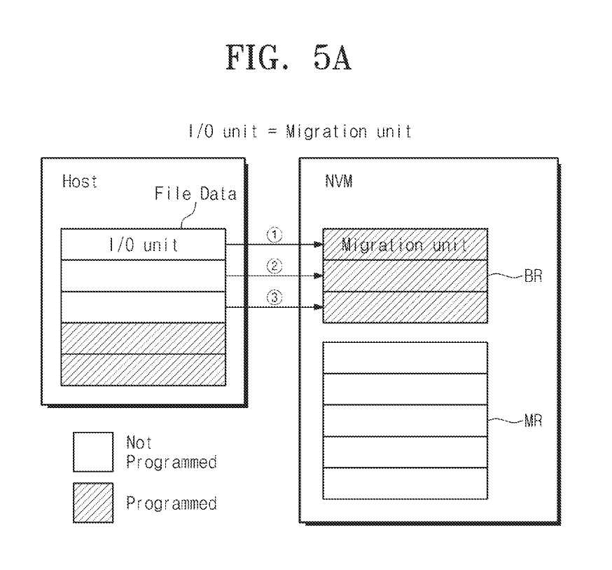

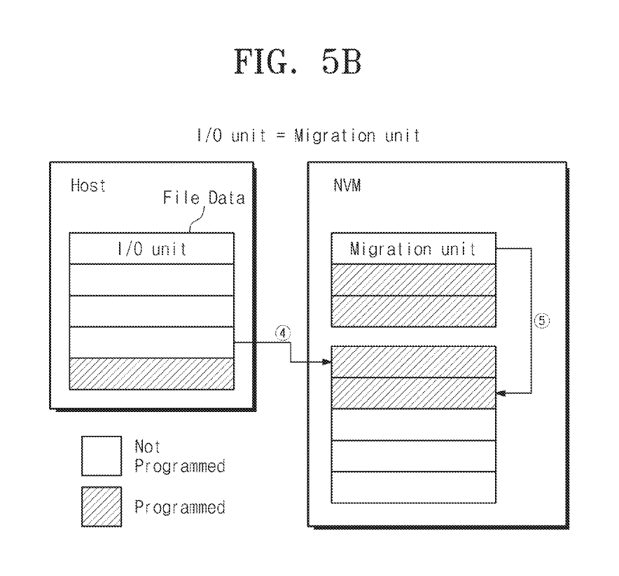

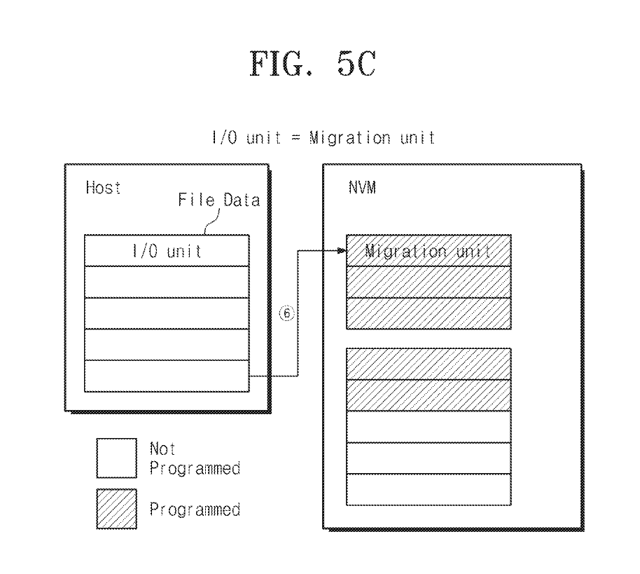

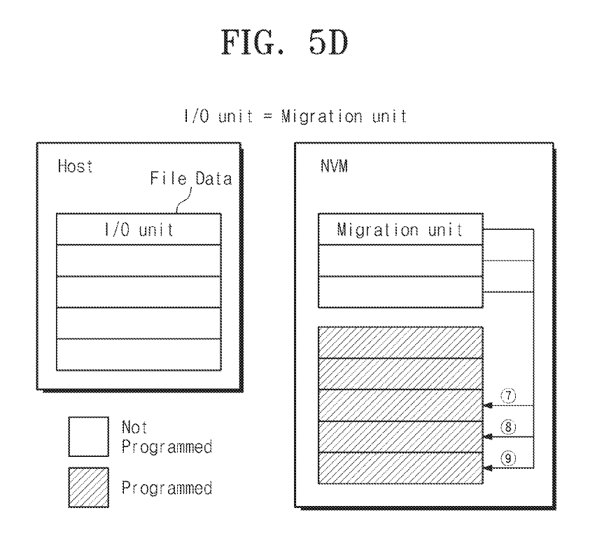

FIGS. 5A to 5D are block diagrams illustrating a program method according to example embodiments of the disclosure when an input/output (I/O) unit and a migration unit are equal to each other. In the method, a host transmits file data desired to be stored to a nonvolatile memory device after dividing the file data into a plurality of input/output (I/O) units of a set size. The I/O unit may be changed by the host. For example, if a size of the file data is relatively large, the host may also set the I/O unit to be large. Meanwhile, if the size of the file data is relatively small, the host may set the I/O unit to be small. For example, if an application executed by the host produces a document, a document file may have a relatively small size and thus an I/O unit may also be set to be small. Meanwhile, if an application executed by the host is related to music or a movie, a music or movie file may have a relatively large size and thus an I/O unit may also be set to be large. Such an I/O unit may be set to, for example, 256 KB, 512 KB, 1 MB, 4 BM or the like, but is not limited to these values.

Referring to FIGS. 5A to 5D, the host may transmit file data desired to be transmitted after dividing the file data in five I/O units. A buffer region BR of a nonvolatile memory device store three migration units. The I/O unit and the migration unit may have different sizes, but in the embodiment described herein the I/O unit and migration unit have the same size.

Referring to FIG. 5A, file data of the host is programmed into the buffer region BR. That is, among the file data, data of three I/O units may be sequentially programmed into the buffer region BR (\textcircled{1}, \textcircled{2}, and \textcircled{3}). As shown in FIG. 5A, when the file data of the host are sequentially programmed into the buffer region BR, the buffer region BR may become full of the programmed file data. That is, a programmable region in the buffer region BR does not exist any longer.

Referring to FIG. 5B, since a programmable region does not exist in the buffer region BR due to the program operation into the buffer region BR in FIG. 5A, data transmitted from the host may not be programmed into the buffer region BR. Accordingly, the memory controller 110 (see FIG. 1) controls the file data transmitted from the host to program the transmitted data into a main region MR of the nonvolatile memory device. That is, file data of a single I/O unit transmitted from the host is directly programmed into the main region MR (\textcircled{4}).

After the program operation into the main region MR (\textcircled{4}), the memory controller 110 controls the nonvolatile memory device to perform a migration program operation (\textcircled{5}) to transmit and program a migration unit of data, among the data programmed into the buffer region BR, into the main region MR. That is, after the program operation into the main region MR (\textcircled{4}), a migration program operation is performed once. The migration program operation (\textcircled{5}) is performed on a migration unit of data of a set size. When the migration program operation (\textcircled{5}) is performed once, a programmable region having the same size as the migration unit may be freed in the buffer region BR

Referring to FIG. 5C, a buffer program operation (\textcircled{6}) is performed on the last I/O unit of data among the file data of the host. More specifically, the memory controller 110 compares a size of a single I/O unit of data with a size of the programmable region in the buffer region BR after the migration program operation (\textcircled{5}). Since a comparison result is that the size of the programmable region in the buffer region BR is equal to that of the I/O unit, a program operation into the buffer region BR (\textcircled{6}) may be performed.

Referring to FIG. 5D, the memory controller 110 sequentially programs the data programmed into the buffer region BR into the main region MR (\textcircled{7}, \textcircled{8}, and \textcircled{9}). The program operation according to FIG. 5D may be performed as a background operation of the nonvolatile memory device. That is, a write operation of the host may be completed by completing the buffer program operation (\textcircled{6}) according to FIG. 5C.

FIGS. 5A to 5D will describe a program operation according to example embodiments of the disclosure by giving an example in which a size of an input/output (I/O) unit of a transmission unit of a host is equal to that of a migration unit of a nonvolatile memory device. Accordingly, since the size of the I/O unit and the size of the migration unit are equal to each other, a region into which a single I/O unit of data may be programmed may be formed in the buffer region BR by a migration program operation performed once.

In a conventional program method, when the buffer region BR is full of data, all data of the buffer region BR migrates to the main region MR. Meanwhile, in a program method according to example embodiments of the disclosure, only data corresponding to a migration unit of a set size migrates. Accordingly, when host data of the same size is programmed, a size of data programmed into a nonvolatile memory device may be reduced to be smaller than in the conventional program method. As a result, a WAF may increase to improve the life of the nonvolatile memory device.

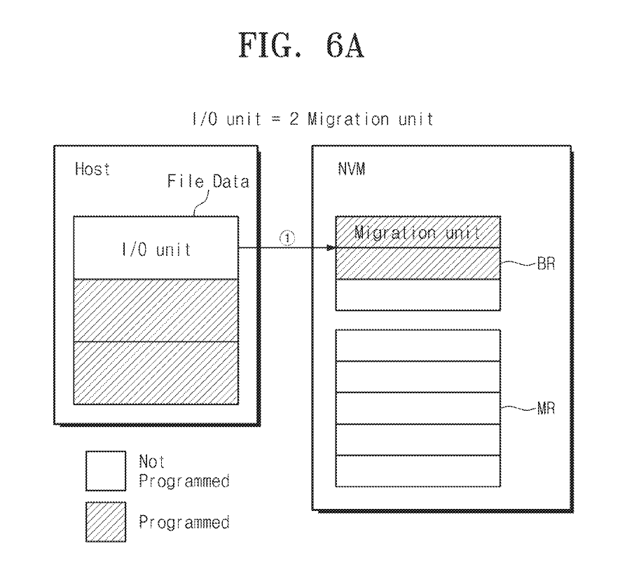

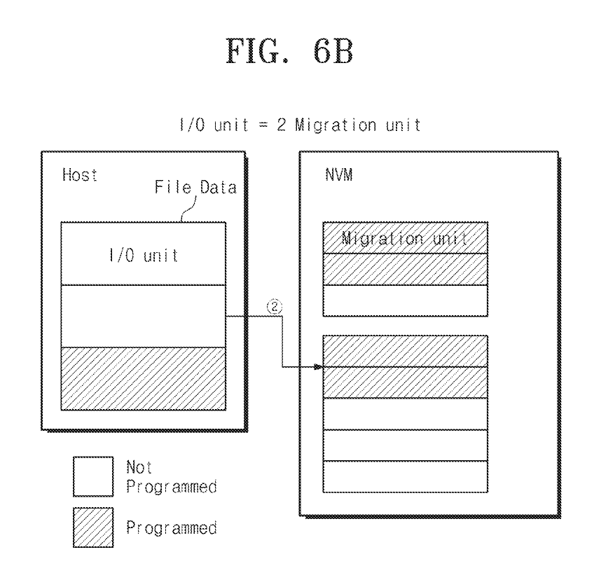

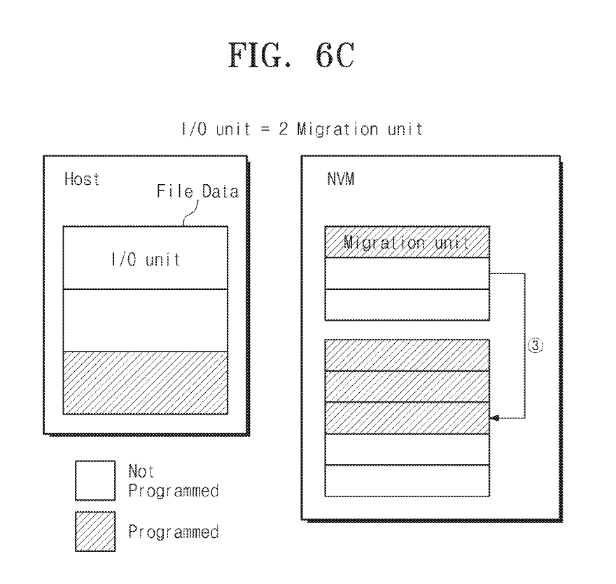

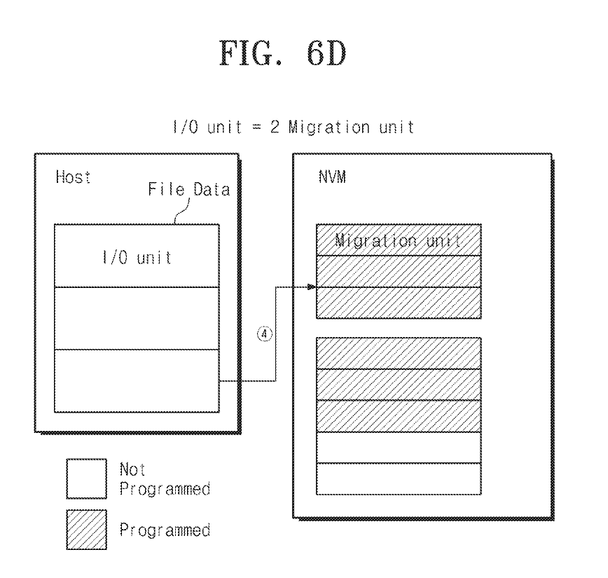

FIGS. 6A to 6D are block diagrams illustrating a program method according to example embodiments of the disclosure when an input/output unit is larger than a migration unit. A host transmits file data desired to be stored to a nonvolatile memory device after dividing the file data in a plurality of input/output (I/O) units, each being a set size. The I/O unit may be varied by the host. The program method according to FIGS. 6A to 6D shows an example in which an I/O unit is two times larger than a migration unit. For example, a size of the file data according to FIGS. 6A to 6D may be larger than that of the file data according to FIGS. 5A to 5D.

Referring to FIGS. 6A to 6D, the host may transmit file data desired to be transmitted after dividing the file data into three I/O units. The buffer region BR of the nonvolatile memory device includes three migration units. A size of the I/O unit is two times larger than that of the migration unit.

Referring to FIG. 6A, the file data of the host is programmed into the buffer region BR. That is, among the file data, a single I/O unit of data may be programmed into the buffer region BR (\textcircled{1}). As shown in FIG. 6A, among the file data of the host, only a single I/O unit of data may be programmed into the buffer region BR. This is because after the program operation into the buffer region BR (\textcircled{1}), a size of a programmable region in the buffer region BR is smaller than that of a single I/O unit.

Referring to FIG. 6B, since a size of the available programmable region in the buffer region BR is made smaller than that of an I/O unit by the program operation into the buffer region BR in FIG. 6A, the I/O unit of data transmitted from the host may be programmed into the main region MR (\textcircled{2}). That is, the memory controller 110 controls the nonvolatile memory device to program the file data transmitted from the host into the main region MR of the nonvolatile memory device.

Referring to FIG. 6C, after the program operation into the main region (\textcircled{2}), the memory controller 110 controls the nonvolatile memory device to perform a migration program operation (\textcircled{3}) to transmit and program a migration unit of data, among the data programmed into the buffer region BR, into the main region MR. That is, after the program operation into the main region MR (\textcircled{2}), a migration program operation is performed once. The migration program operation (\textcircled{3}) is performed on a migration unit of data of a set size. When the migration program operation (\textcircled{3}) is performed once, an available programmable region having the same size as the migration unit may be formed in the buffer region BR.

Referring to FIG. 6D, a buffer program operation (\textcircled{4}) is performed on the last I/O unit of data among the file data of the host. More specifically, the memory controller 110 compares a size of a single I/O unit of data transmitted from the host with a size of an available programmable region in the buffer region BR after the migration program operation (\textcircled{3}). Since a comparison result is that the size of the programmable region in the buffer region BR is made equal to that of the I/O unit by the migration program operation (\textcircled{3}), a program operation into the buffer region BR (\textcircled{4}) may be performed. The host transmits the last remaining I/O unit of data to the nonvolatile memory device, and thus the host write operation is completed. The I/O unit of the transmitted data may be programmed into the buffer region BR, and data programmed into the buffer region BR may migrate to the main region MR during an idle time of the nonvolatile memory device.

FIGS. 6A to 6D illustrate a program operation according to example embodiments of the disclosure when a size of an I/O unit of a transmission unit of a host is two times larger than that of a migration unit of a nonvolatile memory device. Accordingly, since the size of the I/O unit is two times larger than that of the migration unit, a buffer program operation may be performed once, after a direct program operation and a migration program operation are each performed once. Meanwhile, in the program method according to FIGS. 5A to 5D, a buffer program operation may be performed, after a direct program operation and a migration program operation are each performed once. That is, in the program method according to example embodiments of the disclosure, a program count of a buffer region decreases as the size of an I/O unit of data transmitted from the host increases. In addition, a size of data actually programmed into a memory area of the nonvolatile memory device is reduced to complete a write operation of the host. As a result, the program method according to example embodiments of the disclosure may increase a WAF as compared to the foregoing conventional program method. Thus, the life of the nonvolatile memory device increases. Moreover, the WAF increases as a size of an I/O unit transmitted from the host increases.

According to the above-described program method, a migration unit of a migration program operation occurring in a buffer region of a nonvolatile memory device during a write operation of a host may be limited to a set specific-sized unit. That is, the nonvolatile memory device performs the migration program operation in a set migration unit. The migration unit may be a size corresponding to a page size of the nonvolatile memory device or corresponding to an integer fraction or multiple of the page size. The nonvolatile memory device alternately performs a direct program operation and a migration program operation. When a size of an available programmable region in the buffer region is made larger than or equal to that of an input/output unit after the migration operation is performed, the nonvolatile memory device programs data from the host into the buffer region.

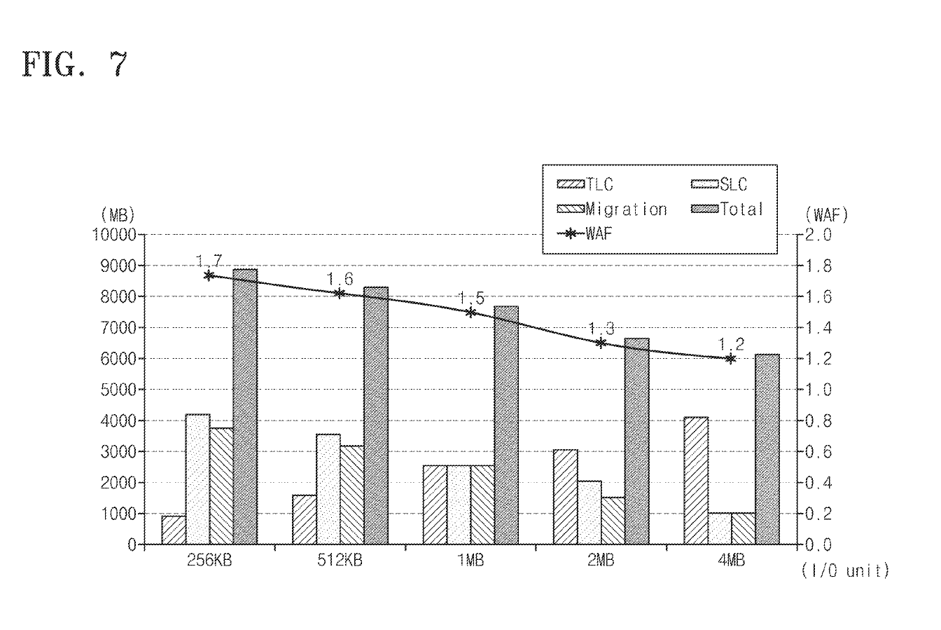

FIG. 7 is a graph illustrating WAF variation depending on an input/output (I/O) unit when a program method according to example embodiments of the disclosure is used. As can be seen from FIG. 7, a WAF decreases as the I/O unit increases.

The graph in FIG. 7 illustrates WAF variation depending on an I/O unit in the case that host data is programmed using a method according to example embodiments of the disclosure when a size of a buffer region including SLC memory cells is 1 GB and a size of the host data is 5 GB.

In the case of using a conventional program method, data totaling 10 GB must be programmed into the buffer and main regions of a nonvolatile memory device to ultimately program host data of 5 GB into the main region of the nonvolatile memory device. The term “conventional program method” refers to a program method including programming transmitted host data into a buffer region, migrating all the data programmed into the buffer region to a main region when the buffer region is full, and repeating these operations. If the conventional program method is used, WAF may be two.

In case of using a program method according to example embodiments of the disclosure, a migration operation is performed in a migration unit of a set size to have a WAF value smaller than 2, which is the WAF according to the conventional program method.

In the program method according to example embodiments of the disclosure, a WAF value may further decrease if an I/O unit of data transmitted from the host increases. The expression “WAF value is small” means that the combined size of data programmed into each of the buffer and main regions of a nonvolatile memory device is smaller. Accordingly, the smaller the WAF value, the longer the life of the nonvolatile memory device.

As can be seen from FIG. 7, as the size of an I/O unit increases, a WAF, a size of data programmed into a buffer region (e.g., SLC), a size of migrated data, and a size of all data (e.g., Total) programmed into a nonvolatile memory device decrease, whereas a size of data programmed into a main region (e.g., TLC) increases. This leads to the expectation that the number of direct program operations will increase when a size of an I/O unit increases while a migration unit is fixed.

If the size of the I/O unit increases, the nonvolatile memory device uses the buffer region relatively less. That is, among the data from the host, a size of data programmed into the buffer region decreases. Thus, performance of the nonvolatile memory device may be degraded due to less use of the buffer region with a high program speed. The degradation in performance may be controlled by increasing the size of the buffer region. This is because when the size of the buffer region is large enough, performance of the buffer region may be maintained until entering a migration program operation.

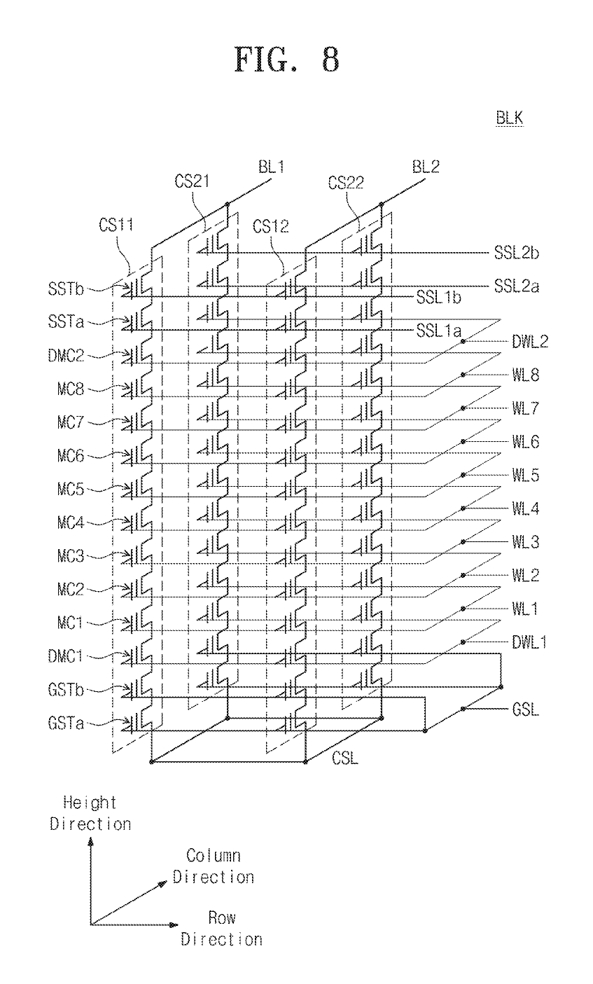

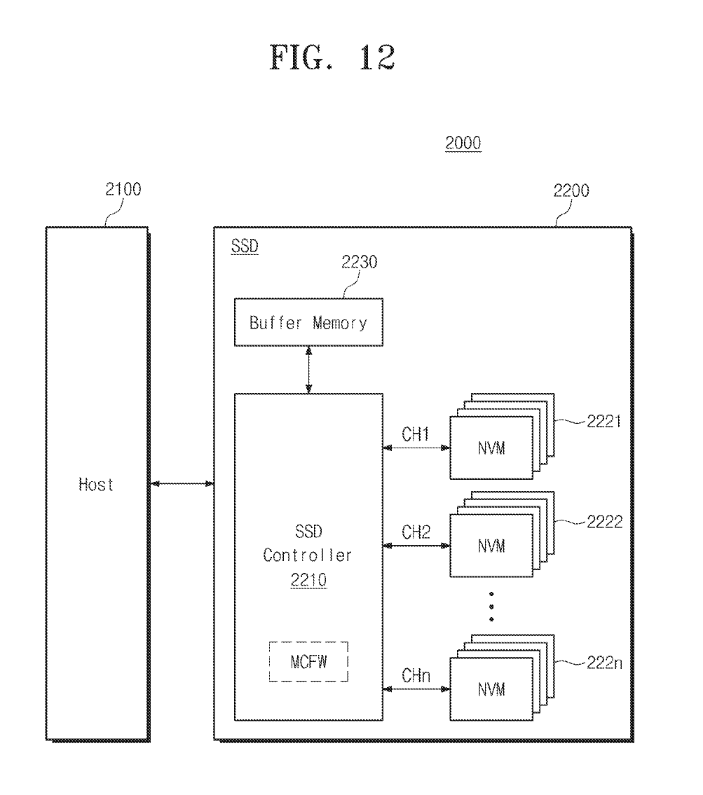

FIG. 8 is a circuit diagram of one of the memory blocks included in a memory cell array in FIG. 3. In example embodiments, a first memory block BLK1 of a three-dimensional structure will be described with reference to FIG. 12.

Referring to FIG. 8, the memory block BLK includes a plurality of cell strings CS11, CS21, CS12, and CS22. The cell strings CS11, CS21, CS12, and CS22 may be arranged in a row direction and a column direction to form rows and columns. For example, the cell strings CS11 and CS12 may be connected to string selection lines SSL1a and SSL1b to form a first row. The cell strings CS21 and CS22 may be connected to string selection lines SSL2a and SSL2b to form a second row. For example, the cell strings CS11 and CS21 may be connected to a first bitline BL1 to form a first column. The cell strings CS12 and CS22 may be connected to a second bitline BL2 to form a second column.

Each of the cell strings CS11, CS12, CS21, and CS22 includes a plurality of cell transistors. For example, each of the cell strings CS11, CS12, CS21, and CS22 may include string selection transistors SSTa and SSTb, a plurality of memory cells MC1 to MC8, ground selection transistors GSTa and GSTb, and dummy memory cells DMC1 and DMC2. In example embodiments, each of a plurality of cell transistors included in the cell strings CS11, CS12, CS21, and CS22 may be a charge trap flash (CTF) memory cell.

The memory cells MC1 to MC8 are connected in series and are stacked in a height direction perpendicular to a substrate formed by a row direction and a column direction. The string selection transistors SSTa and SSTb are connected in series. The serially connected string selection transistors SSTa and SSTb are provided between the memory cells MC1 to MC8 and a bitline BL. The ground selection transistors GSTa and GSTb are connected in series. The serially connected ground selection transistors GSTa and GSTb are provided between the memory cells MC1 to MC8 and a common source line CSL.

In example embodiments, a first dummy memory cell DMC1 may be provided between the memory cells MC1 to MC8 and the ground selection transistors GSTa and GSTb. In exemplary embodiments, a second dummy memory cell DMC2 may be provided between the memory cells MC1 to MC8 and the string selection transistors SSTa and SSTb.

The ground selection transistors GSTa and GSTb of the cell strings CS11, CS12, CS21, and CS22 may be commonly connected to a ground selection line GSL. In example embodiments, ground selection transistors of the same row may be connected to the same ground selection line and ground selection transistors of a different row may be connected to a different selection line. For example, the first ground selection transistor GSTa of the cell strings CS11 and CS12 of a first row may be connected to a first ground selection line and the first ground selection transistor GSTa of the cell strings CS21 and CS22 of a second row may be connected to a second ground selection line.

In example embodiments, although not shown in the drawing, ground selection transistors provided at the same height from a substrate (not shown) may be connected to the same ground selection line and ground selection transistors provided at different heights from the substrate may be connected to different ground selection lines. For example, first ground selection transistors GSTa of the cell strings CS11, CS12, CS21, and CS22 may be connected to a first ground selection line and second ground selection transistors GSTb of the cell strings CS11, CS12, CS21, and CS22 may be connected to a second ground selection line.

Memory cells of the same height from a substrate (or the ground selection transistors GSTa and GSTb) are commonly connected to the same wordline, and memory cells of different heights from the substrate (or the ground selection transistors GSTa and GSTb) are connected to different wordlines. For example, first to eighth memory cells MC1 to MC8 of the cells strings CS11, CS12, CS21, and CS22 are commonly connected to first to eighth wordlines WL1 to WL8, respectively.

Among the first string selection transistors SSTa of the same height, string selection transistors of the same row are connected to the same string selection line and string selection transistors of different rows are connected to different string selection lines. For example, the first string selection transistors SSTa of the cell strings CS11 and CS12 of the first row are commonly connected to a string selection line SSL1a and the first string selection transistors SSTa of the cell strings CS21 and CS22 of the second row are connected to the string selection line SSL2a.

Similarly, among the second selection transistors SSTb of the same height, string selection transistors of the same height are connected to the same string selection line and string selection transistors of different rows are connected to different string selection lines. For example, the string selection transistors SSTb of the cell strings CS11 and CS12 of the first row are commonly connected to a string selection line SSL1b and the string selection transistors SSTb of the cell strings CS21 and CS22 of the second row are commonly connected to the string selection line SSL2b.

Although not shown in the drawing, string selection transistors of cell strings of the same row may be commonly connected to the same string selection line. For example, the first and second string selection transistors SSTa and SSTb of the cell strings CS11 and CS12 of the first row may be commonly connected to the same string selection line. The first and second string selection transistors SSTa and SSTb of the cell strings CS21 and CS22 of the second row may be commonly connected to the same string selection line.

In example embodiments, dummy memory cells of the same height are connected to the same dummy wordline and dummy memory cells of different heights are connected to different dummy wordlines. For example, the first dummy memory cells DMC1 are connected to a first dummy wordline DWL1 and second dummy memory cells DMC2 are connected to a second dummy wordline DWL2.

In the memory block BLK, read and write operations may be performed in units of rows. For example, a single row of a memory block BLKa may be selected by the string selection lines SSL1a, SSL1b, SSL2a, and SSL2b.

For example, when the string selection lines SSL1a and SSL1b are supplied with a turn-on voltage and the string selection lines SSL2a and SSL2b are supplied with a turn-off voltage, the cell strings CS11 and CS12 of the first row are connected to the bitlines BL1 and BL2. When the string selection lines SSL2a and SSL2b are supplied with a turn-on voltage and the string selection lines SSL1a and SSL1b are supplied with a turn-off voltage, the cell strings CS21 and CS22 of the second row are connected to the bitlines BL1 and BL2 to be driven. Among memory cells of a cell string of a row driven by driving a wordline, memory cells of the same height are selected. Read and write operation may be performed on the selected memory cells. The selected memory cells may form a physical page unit.

In the memory block BLK, an erase operation may be performed in units of memory blocks or sub-blocks. When an erase operation is performed in units of memory blocks, all memory cells MC of the memory block BLK may be simultaneously erased according to a single erase request. When an erase operation is performed in units of sub-blocks, some of memory cells MC of the memory block BLK may be simultaneously erased according to a single erase request and the other memory cells may be erase-inhibited. A wordline connected to the erased memory cells may be supplied with a low voltage (e.g., ground voltage), and a wordline connected to the erase-inhibited memory cells may be floated.

In exemplary embodiments, the memory block BLK shown in FIG. 8 is merely exemplary, the number of cell strings may increase or decrease, and the number of rows and columns constituted by cell strings may increase or decrease according to the number of the cell strings. Moreover, the number of cell transistors GSTS, MC, DMC, SST, and the like of the memory block BLK may increase or decrease, and height of the memory block BLK may increase or decrease according to the number of the cell transistors. The number of lines GSL, WL, DWL, SSL, and the like connected to the cell transistors may increase or decrease according to the number of the cell transistors.

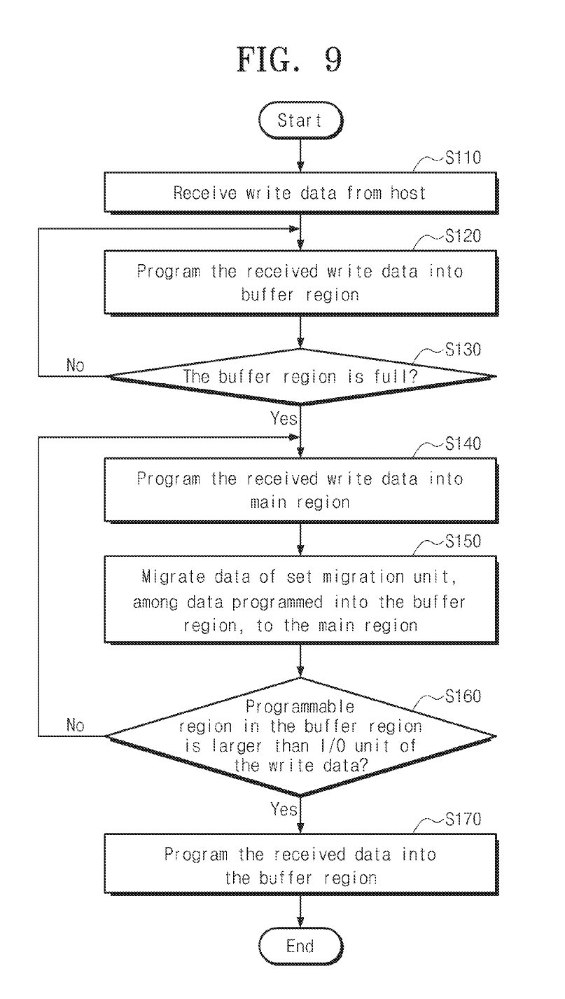

FIG. 9 is a flowchart summarizing a program operation according to example embodiments of the disclosure. Referring to FIG. 9, when a buffer region is all programmed with write data transmitted from a host, the data programmed into the buffer region migrates to a main region in a migration unit of a set size. That is, all data programmed into the buffer region does not migrate to the main region at one time but only data of a set size migrates to the main region during each migration operation. Hereinafter, a program operation according to example embodiments of the disclosure will now be described with reference to FIG. 9.

A nonvolatile memory device receives write data from a host (S110). The write data may be transmitted in an input/output (I/O) unit of a set (i.e., established) size. That is, the nonvolatile memory device receives write data, corresponding to the next I/O unit, to perform a program operation after programming write data, corresponding to a single I/O unit, into a buffer region or a main region.

The nonvolatile memory device programs the received write data into the buffer region (S120).

A memory controller checks whether the buffer region is all programmed (e.g., full) with the write data (S130). That is, the memory controller checks whether the write data transmitted from the host may be programmed into the buffer region. When the buffer region is not all programmed with the write data, i.e., the buffer region is not full, the flow returns to S120. Thus, the received write data may be programmed into the buffer region. When the buffer region is all programmed with the write data, the flow proceeds to S140.

The nonvolatile memory device programs the received write data into the main region (S140). That is, the nonvolatile memory device directly programs the received write data into the main region without passing through the buffer region.

The nonvolatile memory device migrates data of a migration unit that is a set size, among the data programmed into the buffer region, to the main region (S150). The migration unit may be a size corresponding to a page size of the nonvolatile memory device or an integer multiple of the page size. The migration unit may vary depending on situations.

The memory controller checks whether a size of the programmable region in the buffer region is larger than the I/O unit of the write data (S160). When the size of the programmable region in the buffer region is larger than the I/O unit, the flow returns to S140. That is, after the received data is programmed into the main region S140 and operation S150 is performed, operation S160 causes operations S140 and S150 to be repeated. When the size of the programmable region in the buffer region is larger than the I/O unit, the nonvolatile memory device programs the received write data into the buffer region S170.

According to the above-described program method, a size of migrated data is limited to a set size during a migration operation that occurs during a program operation performed on input/output data received from a host. Due to the limitation in the size of the migrated data, a buffer region may be less used to increase the life of the buffer region. In addition, when the same input/output data is programmed into a nonvolatile memory device, a size of data actually programmed into the nonvolatile memory device is reduced as compared to that in the above-described conventional program method. Thus, a WAF may be reduced. When the WAF is reduced, the life of the nonvolatile memory device may increase.

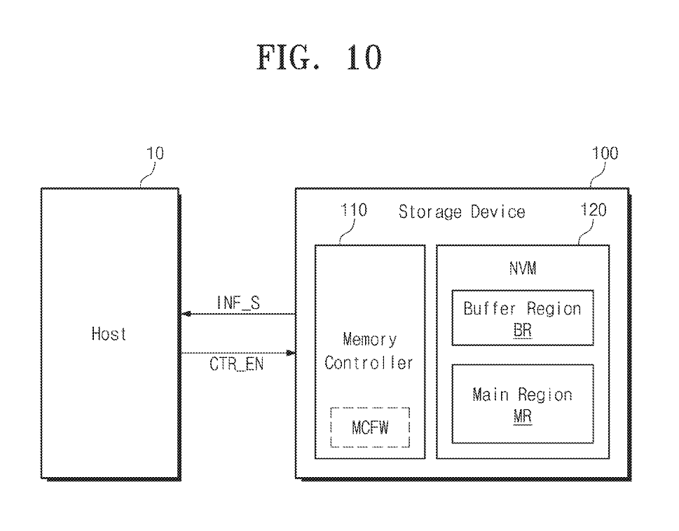

FIG. 10 is a block diagram of a memory system including a storage device according to example embodiments of the disclosure. As illustrated, the memory system includes a host 10 and a storage device 100. The storage device 100 has migration control firmware MCFW embedded therein to perform the above-described program operation according to example embodiments of the disclosure.

The host 10 may control the storage device 100 to program host data or read written data. The host 10 may communicate with the host interface 115 (see FIG. 2) of the memory controller 110. For example, the host 10 may communicate with the storage device 100 using at least one of USB (universal serial bus), MMC (multimedia card), embedded-MMC, PCI (peripheral component interconnection), PCI express, ATA (advanced technology attachment), serial-ATA, parallel-ATA, SCSI (small computer small interface), ESDI (enhanced small disk interface), IDE (integrated drive electronics), Firewire, and UFS (universal flash storage). The host 10 may be a computing device such as a desktop computer, a laptop computer, or a mobile phone. However, the host 10 is not limited thereto and may include all electronic devices using a nonvolatile memory device as a storage medium.

The storage device 100 may perform the above-described program operation according to example embodiments of the disclosure. The memory controller 110 may execute the migration control firmware MCFW stored in an internal memory to perform program operations according to example embodiments of the disclosure. When the migration control firmware MCFW is executed, the memory controller 110 may control the nonvolatile memory device 120 to perform the above-described program operation according to example embodiments of the disclosure on a buffer region BR and a main region MR of the nonvolatile memory device 120. For example, when data transmitted from the host is programmed into the buffer region BR and the buffer region BR is all programmed with host data, the data transmitted from the host may be programmed into the main region MR. After the data transmitted from the host is programmed into the main region MR, data of a size corresponding to a set migration unit, among the data programmed into the buffer region BR, may migrate to the main region MR.

For example, let it be assumed that the host 10 is a mobile phone and the storage device 100 is an SD card inserted into the mobile phone to perform a memory function. When the SD card is inserted first into the mobile phone, the SD card may transmit its state information INF_S to the mobile phone. An application processor of the mobile phone may control operation of the inserted SD card using the state information INF_S. When the migration control firmware MCFW is embedded in the SD card, the state information INF_S transmitted by the SD card may include information on the migration control firmware MCFW. The host 10 may transmit, to the storage device 100, a control signal CTR_EN concerning whether or not to perform a program operation through the migration control firmware MCFW based on the state information INF_S. That is, the control signal CTR_EN is a signal concerning whether or not to use a program operation, according to example embodiments of the disclosure, in the storage device 100. In response to the control signal CTR_EN transmitted by the host 10, the storage device 100 may execute or not execute the migration control firmware MCFW according to example embodiments of the disclosure.

The above-described memory system in FIG. 10 may selectively decide whether to enable or disable a program operation in the storage device 100 according to the control of the host 10.

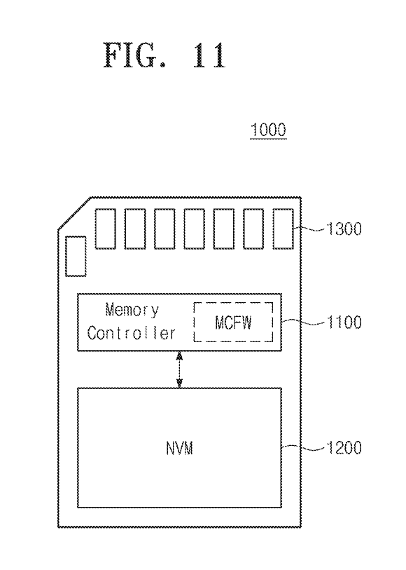

FIG. 11 is a block diagram of a memory card system 1000 to which a storage device according to example embodiments of the disclosure is applied. As illustrated, the memory card system 1000 includes a controller 1100, a nonvolatile memory 1200, and a connector 1300.

The controller 1100 is connected to a nonvolatile memory 1200. The controller 1100 is configured to access the nonvolatile memory 1200. For example, the controller 1100 is configured to control read, write, erase, and background operations of the nonvolatile memory 1200. The background operation includes operations such as wear-leveling management and garbage collection.

The controller 1100 stores migration control firmware MCFW according to example embodiments of the disclosure in an internal memory and executes the migration control firmware MCFW. When the controller 1100 executes the migration control firmware MCFW, the above-described program operation may be performed on the nonvolatile memory device 1200.

The controller 1100 is configured to provide interfacing between the nonvolatile memory 1200 and a host. The controller 1100 is configured to drive firmware for controlling the nonvolatile memory device 1200.

In example embodiments, the controller 1100 may include elements such as a random access memory (RAM), a processing unit, a host interface, a memory interface, and an error correction unit.

The controller 1100 communicates with an external device through the connector 1300. The controller 1100 communicates with an external device according to a particular communication protocol. For example, the controller 1100 may communicate with the external device through at least one of various interface protocols such as, but not limited to, USB (Universal Serial Bus), MMC (multimedia card), eMMC (embedded MMC), PCI (peripheral component interconnection), PCI-E (PCI-express), ATA (Advanced Technology Attachment), Serial-ATA, Parallel-ATA, SCSI (small computer small interface), ESDI (enhanced small disk interface), IDE (Integrated Drive Electronics), Firewire, UFS (Universal Flash Storage), and NVMe (Nonvolatile Memory express).

The nonvolatile memory 1200 may be implemented with various nonvolatile memory devices such as an electrically erasable and programmable read only memory (EPROM), a NAND flash memory, a NOR flash memory, a phase-change RAM (PRAM), a resistive RAM (ReRAM), a ferroelectric RAM (FRAM), and a spin-torque magnetic RAM (STT-MRAM).

In example embodiments, the controller 1100 and the nonvolatile memory device 1200 may be integrated into a single semiconductor device. In example embodiments, the controller 1100 and the non-volatile memory device 1200 may be integrated into a single semiconductor device to constitute a solid state drive (SSD). The controller 1100 and the non-volatile memory device 1200 may be integrated into a single semiconductor device to constitute a memory card. For example, the controller 1100 and the nonvolatile memory device 1200 may be integrated into a single semiconductor device to constitute a memory card such as a PC card (PCMCIA, personal computer memory card international association), a compact flash card (CF), a smart media card (SM, SMC), a memory stick, a multimedia card (MMC, RS-MMC, MMCmicro, eMMC) an SD card (SD, miniSD, microSD, SDHC), and a universal flash storage (UFS).

The nonvolatile memory device 1200 or the memory card system 1000 may be mounted in various types of packages. For example, the nonvolatile memory device 1200 or the memory card system 1000 may be packaged by one of a package on package (PoP), ball grid assays (BGAs), chip scale packages (CSPs), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small outline (SOIC), shrink small outline package (SSOP), a thin small outline package (TSOP), a system in package (SIP), a multi-chip package (MCP), a wafer-level fabricated package (WFP), and a wafer-level processed stack package (WSP).

FIG. 12 is a block diagram of a solid state drive (SSD) system 2000 to which a storage device according to example embodiments of the disclosure is applied. As illustrated, the SSD system 2000 includes a host 2100 and an SSD 2200. The SSD 2200 includes an SSD controller 2210, a plurality of flash memories 2221 to 222n, and a buffer memory 2230.

The SSD controller 2210 may control the flash memories 2221 to 222n in response to a signal received from the host 2100. The SSD controller 2210 may store migration control firmware MCFW according to example embodiments of the disclosure in an internal memory and execute the migration control firmware MCFW. When the SSD controller 2210 executes the migration control firmware MCFW, the above-described program operation may be performed on the flash memories 2221 to 222n. The flash memories 2221 to 222n may perform a program operation according to the control of the SSD controller 2210.

The buffer memory 2230 operates as a buffer memory of the SSD 2200. For example, the buffer memory 2230 may temporarily store data received from the host 2100 or data received from the flash memories 2221 to 222n or may temporarily store metadata (e.g., mapping table) of the flash memories 2221 to 222n. The buffer memory 2230 may include a nonvolatile memory such as DRAM, SDRAM, DDR SDRAM, LPDDR SDRAM, and SRAM or a nonvolatile memory such as FRAM ReRAM, STT-MRAM, and PRAM.

As described so far, according to example embodiments of the disclosure, the life of a nonvolatile memory device may increase.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The above-disclosed subject matter is to be considered illustrative, and not restrictive, and the appended claims are intended to cover all such modifications, enhancements, and other features, which fall within the true spirit and scope of the disclosure. Thus, to the maximum extent allowed by law, the scope of the disclosure is to be determined by the broadest permissible interpretation of the following claims and their equivalents, and shall not be restricted or limited by the foregoing detailed description. While some example embodiments have been particularly shown and described, it will be understood by one of ordinary skill in the art that variations in form and detail may be made therein without departing from the spirit and scope of the claims.

What is claimed is:

1. A storage device comprising:
a nonvolatile memory device including memory blocks divided into a buffer region and a main region; and
a memory controller configured to control the nonvolatile memory device to perform a buffer program operation to program externally provided data into the buffer region, a migration program operation to migrate data stored in the buffer region to the main region, and a direct program operation to program the externally provided data into the main region, wherein:
the direct program operation is performed when a size of the externally provided data is larger than that of a programmable region in the buffer region, and
the migration program operation is performed to migrate some of the data programmed into the buffer region to the main region after the direct program operation is performed.

2. The storage device as set forth in claim 1, wherein the direct program operation and the migration program operation are alternately performed until the size of the programmable region in the buffer region is made larger than that of the externally provided data.

3. The storage device as set forth in claim 2, wherein the externally provided data is programmed into the buffer region when the size of the programmable region in the buffer region is made larger than that of the externally provided data.

4. The storage device as set forth in claim 1, wherein the size of the migrated data is a page size of the nonvolatile memory device or an integer multiple of the page size.

5. The storage device as set forth in claim 1, wherein each memory cell of the buffer region is managed as a single-level cell and each memory cell of the main region is managed as a multi-level cell.

6. The storage device as set forth in claim 1, wherein the externally provided data is repeatedly inputted as an input/output unit of a set size.

7. The storage device as set forth in claim 1, wherein the nonvolatile memory device includes a three-dimensional memory cell array.

8. A program method of a nonvolatile memory device, the method comprising:
a first program operation to program data, input externally in an input unit of a set size, into a first memory region;
a second program operation to program externally input data into a second memory region when the first memory region is fully programmed with externally input data; and
a third program operation to migrate some of the data programmed into the first memory region to the second memory region, wherein
the size of the migrated data corresponds to a page size of the nonvolatile memory device or an integer multiple of the page size.

9. The program method as set forth in claim 8, wherein the first program operation is repeatedly performed until the first memory region is fully programmed.

10. The program method as set forth in claim 8, wherein the second program operation and the third program operation are alternately performed until the size of an available programmable region in the buffer region is made larger than the input unit.

11. The program method as set forth in claim 10, further comprising a fourth program operation to program externally input data into the buffer region when the size of the available programmable region in the buffer region is larger than the input unit.

12. The program method as set forth in claim 11, wherein each of the first program operation, the second program operation, and the fourth program operation is performed to program externally input data of the input unit.

13. The program method as set forth in claim 8, wherein each memory cell of the first region is managed as a single-level cell and each memory cell of the second region is managed as a multi-level cell.

14. The program method as set forth in claim 8, wherein each memory cell of the second region is managed in a triple-level cell manner.

15. The program method as set forth in claim 8, wherein the nonvolatile memory device includes a three-dimensional memory array.

16. A method, executed by a memory controller, of programming data into a nonvolatile memory having a buffer region and a main region, the method comprising:
a) receiving an input unit of data from a host device;
b) programming the input unit of data into the buffer region when the buffer region has enough available memory to store the input unit of data;
c) programming the input unit of data into the main region when the buffer region does not have enough available memory to store the input unit of data; and
d) migrating a migration unit of data stored in the buffer region to the main region after programming the input unit of data into the main region and before programming additional data, received from the host, into either the buffer region or the main region, the migration unit being less than all of the data stored in the buffer region.

17. The method of claim 16, further comprising repeating operations (a) through (d).

18. The method of claim 16, wherein operation (d) is executed no more than once after operation (c), if another input unit of data is awaiting receipt from the host device.

19. The method of claim 16, wherein the size of the input unit is variable.

20. The method of claim 16, wherein the size of the migration unit is smaller than the size of the input unit.
